(19) United States
(12) Patent Application Publication
(10) Pub. No.: US 2026/0017693 A1
(43) Pub. Date: Jan. 15, 2026

(54) ADVERTISING PAYMENT SYSTEM AND METHOD

(71) Applicant: Sobir Tokhtabayev, Lakewood Ranch, FL (US)

(72) Inventor: Sobir Tokhtabayev, Lakewood Ranch, FL (US)

(21) Appl. No.: 19/269,973

(22) Filed: Jul. 15, 2025

Related U.S. Application Data
(60) Provisional application No. 63/671,376, filed on Jul. 15, 2024.

(51) Int. Cl. G06Q 30/0273; G06Q 20/02; G06Q 20/36

(52) U.S. Cl. CPC G06Q 30/0273; G06Q 20/02; G06Q 20/3678; G06Q 2220/00

(57) ABSTRACT

The advertising payment system and method includes an interactive website or mobile application having an interface allowing for sellers to create advertising images overlaid with visual codes and a blockchain protocol associated with the interactive webpage or mobile application. The blockchain protocol creates advertising tokens to represent the value that the seller assigns to the sharing of the advertising image. Once a client advertiser scans the visual code and chooses to further share the advertising image, the client advertiser receives the advertising tokens in a virtual wallet. The advertising payment system and method utilizes blockchain technology to incentivize and pay client advertisers, thereby allowing sellers to avoid engaging in the traditional bidding process by facilitating direct communication between sellers and client advertisers.

### CROSS-REFERENCE TO RELATED APPLICATION

This patent application claims priority to U.S. Provisional Patent Application Ser. No. 63/671,376 filed on Jul. 15, 2024, the entire disclosure of which is hereby incorporated herein by reference.

### FIELD

The present invention relates generally to a transaction system. In particular, the invention is directed to an advertising payment system and method that utilizes blockchain technology for incentivizing and paying client advertisers.

### BACKGROUND OF THE INVENTION

There are many circumstances wherein it is desirable for sellers of goods and services to advertise their goods and services to the public. Sellers may choose to advertise their products in public using signs, flyers, billboards, or other tangible methods; however, sellers of goods and services may also choose to advertise their products online.

When advertising online, sellers commonly have to engage in a bidding system with the search engine or website where the seller would like to advertise their product. Bidding may occur in a few ways, with most sellers focusing on maximizing the amount of clicks, impressions, conversions, or views that their advertisement receives. Typically, however, the bidding process constitutes a multi-step process where sellers must create an advertisement, designate keywords relevant to that advertisement, and then bid on the relevant keywords through designating a budget and a cost-per-click that the seller is willing to spend. When an internet user queries a search using the search engine or online platform, a combination of factors will determine whether or not the seller's advertisement is shown. Typically, the seller who is willing to spend the most amount of money per click, who has a high expected click-through rate, and whose designated keywords are most similar to the search query will have their advertisement shown at the highest rate. Then, if the user clicks on the advertisement that is shown, the seller will have to pay the search engine the amount that it was willing to pay per click. This system has shown to create a high return on investment for high-volume sellers who partake in this kind of advertising method.

There are drawbacks, however, to this bidding system. The first main issue is that the system is overly complicated and requires large sums of money in order to advertise efficiently and effectively. This harms mostly small business, who may struggle to compete with large companies who have much greater advertising budgets and advertising teams. The second main issue is that the clients of the sellers who are interested in the sellers' products do not benefit at all from the bidding process. In fact, the clients' clicks are used to pay the search engine or website advertising monies.

There are also several technical shortcomings associated with traditional online advertising methods that disadvantage the client and/or that lead to shortcomings in the bidding system efficiency. As one example, traditional online advertising methods typically rely on centralized servers or intermediaries to handle ad distribution, engagement tracking, and payment execution. These systems are vulnerable to data manipulation, delayed payment, and fraudulent attribution, particularly where advertisement sharing is crowdsourced or distributed across multiple platforms. Manual or opaque server-side processes also limit scalability and impose trust burdens on participants who must rely on the integrity of a central operator to properly execute incentive payments.

Conventional advertising mechanisms also lack real-time client-side validation of promotional identifiers, such as visual codes (e.g., QR codes), prior to network communication with remote servers. This limitation increases latency, consumes unnecessary bandwidth, and exposes systems to fraudulent redirection or spoofed visual code attacks. Accordingly, improved mechanisms are needed to validate visual advertising codes at the device level prior to engaging backend systems or executing redirection events.

Moreover, existing systems often rely on unsecured or plaintext encoding of advertising identifiers such as URLs or QR codes, making them susceptible to spoofing, replay attacks, and fraudulent redirection. Without a cryptographic mechanism for validating the authenticity of the data embedded within visual codes, malicious actors may inject tampered advertisements or impersonate legitimate campaigns. A lack of verifiable origin or signature within these codes presents security vulnerabilities that reduce trust and render the system unsuitable for distributed incentive models involving digital rewards.

In addition, conventional visual code scanning systems typically rely on generic camera APIs and basic decoding libraries, offering limited performance in challenging lighting conditions, skewed image angles, or partial occlusions. This results in failed or slow scans, frustrating user experiences, and increased support needs. Furthermore, such systems often offload image analysis to backend servers, introducing latency and bandwidth overhead. There remains a need for improved visual code recognition mechanisms that operate directly on the client device using optimized computer vision routines tailored to decentralized advertising environments.

Traditional advertising platforms generally implement static redirection behavior when a visual code is scanned, regardless of the capabilities or context of the user device. This one-size-fits-all approach can lead to suboptimal user experiences, such as attempts to launch resource-heavy content on bandwidth-limited networks or directing users to unsupported platforms. These issues are exacerbated in mobile advertising environments where devices vary widely in display size, operating system, network conditions, and browser capabilities. Accordingly, there is a need for a system that can dynamically adjust redirection targets or behaviors based on client-side technical parameters to ensure reliable, efficient, and context-aware interactions.

Still further, conventional advertising platforms rely on centralized application servers to manage token distribution, handle business logic, and track client activity. These centralized architectures create performance bottlenecks, introduce single points of failure, and increase the risk of manipulation or downtime due to overload or malicious attack. Moreover, centralized systems require continuous resource provisioning and infrastructure maintenance. There is a need for more resilient and scalable alternatives that leverage decentralized, serverless computing environments to securely and reliably execute incentive logic without requiring persistent backend infrastructure.

As another technical disadvantage, existing advertising incentive systems often require users to disclose personal or device-identifiable information in order to participate in rewards programs. For instance, user identifiers, device metadata, or behavioral logs may be collected and stored during ad sharing, visual code scanning, or reward disbursement. This undermines user privacy and may expose sensitive information to centralized servers or third-party trackers. There is a growing need for decentralized advertising platforms that support token distribution and event validation while minimizing or eliminating the exposure of personally identifiable information (PII), especially in environments subject to privacy regulations or user data constraints.

In addition to the above deficiencies, existing advertising platforms often fail to provide participants with a transparent and verifiable account of advertisement performance and reward disbursement. Traditional systems rely on opaque, server-side processing that provides little real-time visibility to users, and particularly those involved in incentive-driven ad distribution models. This lack of visibility fosters distrust, enables fraud, and impedes effective self-regulation. Small businesses and individual advertisers in particular are disadvantaged when they are unable to verify how tokens are allocated, whether ad impressions are genuine, or if transaction records are trustworthy.

Finally, traditional advertising systems often operate in closed environments that do not support integration with external token wallets, identity providers, or decentralized application (dApp) ecosystems. This lack of interoperability restricts user flexibility, locks participants into proprietary systems, and complicates reward redemption or further use of earned tokens. A need exists for advertising platforms that can interface seamlessly with external wallets and third-party services while maintaining secure, standards-compliant communication between systems.

Accordingly, there is a need for an improved advertising incentive system that includes user-facing transparency and auditability features. These features would preferably operate in conjunction with decentralized blockchain infrastructure to ensure the verifiability of transactions, prevent reward misallocation, and promote confidence among participants engaging in distributed advertising activity.

### BRIEF SUMMARY

In harmony and accordance with the present disclosure, an advertising payment system and method utilizing blockchain technology is surprisingly discovered.

According to an embodiment of the invention, a system for facilitating advertising transactions between a seller and a client advertiser comprises one or more processors, a blockchain protocol executed by the one or more processors with the blockchain protocol including a plurality of smart contracts configured to govern token generation, allocation, and conditional transfer events, a graphical user interface configured to be accessed by a first smart device associated with the seller with the graphical user interface comprising a token issuing menu configured to enable the seller to acquire advertising tokens through conversion of fiat or cryptocurrency with the advertising tokens representing a digital reward value assignable to advertising sharing events and an advertising image generator menu configured to receive from the seller a visualization associated with a product or service and parameters defining one or both of a total advertising budget and/or a reward amount per each sharing event, a visual code generator executable by the one or more processors to encode information regarding the product or service into a visual code and to generate an advertising image comprising the visualization and the visual code, a redirection module configured to redirect a second smart device associated with the client advertiser to a web address associated with the graphical user interface of the system in response to an interaction of the client advertiser with the visual code, and a decentralized token disbursement module configured to execute a smart contract on the blockchain protocol to conditionally release advertising tokens from a digital wallet associated with the seller to a digital wallet associated with the client advertiser with the smart contract being triggered upon a verified sharing event performed by the client advertiser with respect to the advertising image. The smart contract defines disbursement conditions based at least in part on confirmation of the client advertiser sharing the advertising image or a link derived therefrom.

A method of facilitating advertising transactions between a seller and a client advertiser is also disclosed and includes steps of executing, by one or more processors, a blockchain protocol comprising a plurality of smart contracts configured to govern token generation, allocation, and conditional transfer events; providing, via a graphical user interface accessible by a first smart device associated with the seller: a token issuing menu enabling the seller to acquire advertising tokens through conversion of fiat or cryptocurrency, the advertising tokens representing a digital reward value assignable to advertising sharing events; and an advertising image generator menu configured to receive from the seller a visualization associated with a product or service and parameters defining one or both of a total advertising budget and/or a reward amount per each sharing event; generating, by a visual code generator executable by the one or more processors, a visual code encoding information regarding the product or service; producing an advertising image comprising the visualization and the visual code; publishing the advertising image on a platform such that it is accessible to a second smart device associated with the client advertiser; in response to an interaction by the client advertiser with the visual code via the second smart device, redirecting the second smart device to a web address associated with the graphical user interface of the system; receiving, by the system, confirmation of a verified sharing event performed by the client advertiser with respect to the advertising image or a link derived therefrom; and executing, by one of the smart contracts within the blockchain protocol, a conditional transfer of advertising tokens from a digital wallet associated with the seller to a digital wallet associated with the client advertiser, in accordance with disbursement conditions defined by the one of the smart contracts.

The advertising payment system and method that utilizes blockchain technology to incentivize and pay client advertisers cures the numerous deficiencies of prior art advertising methods. The advertising payment system and method allows sellers to avoid engaging in the traditional bidding process by facilitating direct communication between sellers and client advertisers. This direct communication allows client advertisers to directly share a seller's advertisement to their own social network for a monetary reward. This means that client advertisers directly benefit from advertising, and sellers can directly pay client advertisers for advertising the seller's product. This invention is also beneficial for small businesses because it enables all businesses to advertise their products regardless of the business' budget or the size of the advertising team.

The advertising payment system and method includes an interactive website or mobile application having an interface allowing for sellers to create advertising images overlaid with visual codes and a blockchain protocol associated with the interactive webpage or mobile application. The blockchain protocol creates advertising tokens to represent the value that the seller assigns to the sharing of the advertising image. Once a client advertiser scans the visual code and chooses to further share the advertising image, the client advertiser receives the advertising tokens in a virtual wallet.

In an embodiment of the present disclosure, a method of paying for the advertising of a good or service includes negotiating a transaction between a seller and an advertising payment system regarding the acquirement of advertisement tokens by the seller via use of a first smart device, the negotiating of the transaction occurring via communications occurring between the first smart device and another device as facilitated by the advertising payment system.

The method further includes creating an advertising image, by the seller, via use of the first smart device, the advertising image including a visualization of a good or service and a visual code including information regarding the good or service, the visual code configured to be interacted with by a client advertiser for the good or service via the use of a second smart device.

The method further includes sharing the advertising image to a first platform, by the seller, via use of the first smart device, wherein the advertising image is configured to be visible to the client advertiser during navigation of the platform.

Then, the method further includes interacting with the visual code of the advertising image, by the client advertiser, via the use of the second smart device, the interacting with the visual code including one of: scanning the visual code using a camera of the second smart device when the visual code is visibly displayed on a graphical interface of a third smart device during navigation of the online platform via the third smart device, or detecting a presence of the visual code being visibly displayed on a graphical interface of the second smart device during navigation of the online platform via the second smart device and prompting the buyer to select the visual code following detection thereof.

The method further includes redirecting an application executing on the second smart device to a first web address managed by an advertising payment system provided independently of the online platform in response to the interacting of the client advertiser with the visual code via use of the second smart device, wherein the redirecting of the application to the web address is based on the information of the visual code and an analysis of the information of the visual code via the second smart device, and wherein the web address is associated with a user interface of the advertising payment system.

The method further includes negotiating a transaction of the advertising tokens between the client advertiser and the seller regarding the advertisement of the good or service using the advertising image corresponding to the visual code interacted with by the client advertiser following the redirecting of the second smart device to the user interface of the advertising payment system, the negotiating of the transaction occurring via communications occurring between the first smart device and the second smart device as facilitated by the advertising payment system independently of the online platform as to which the advertising image is shared.

Finally, the method further includes sharing an advertising link that is created by the advertising image to a second platform, by the client advertiser, via the use of the second smart device, wherein the client advertiser may receive the negotiated amount of advertising tokens in exchange for sharing the advertising link to the second platform.

As aspects of some embodiments, the visual code is a QR-code or bar code.

As aspects of some embodiments, the visual code is displayed over or adjacent the visualization of the good or service associated therewith.

As aspects of some embodiments, the platform is a social network or online marketplace.

As aspects of some embodiments, the platform is an offline marketplace.

As aspects of some embodiments, the advertising image is visible to the client advertiser when navigating the online platform prior to the client advertiser providing login credentials to the online platform.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 shows a display of the web page or mobile application used for negotiating the transaction regarding the acquirement of advertisement tokens by seller from the advertising payment system.

FIG. 2 shows a display of the web page or mobile application used for creating the advertising image that includes a visualization of the good or service and a visual code including information regarding the good or service.

FIG. 3 shows a display of the web page or mobile application used for negotiating the transaction of the advertising tokens between the seller and the client advertiser and enabling client advertisers to share an advertising link.

FIG. 4 is a flowchart showing one method of operation of a system managing the web page or mobile application according to an embodiment of the present invention.

### DETAILED DESCRIPTION OF THE INVENTION

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical, unless stated otherwise.

The present invention generally relates to an advertising payment system and method that is capable of utilizing blockchain technology for incentivizing client advertisers to share an advertising image 300 created by the advertising payment system and method. Although certain exemplary transactions are disclosed herein, it should be apparent that the system and methods disclosed herein may be adapted to other related transactions associated with different exchanges, goods, property rights, or services than those specifically described herein. Any examples provided herein regarding the advertisement of consumer goods or services may similarly be adapted to apply to various services or other contractual obligations without necessarily departing from the scope of the present invention. As used hereinafter, references to terms such as “products” or “goods” that may be advertised via the advertising payment system may also be considered to be representative of intangible property, such as intellectual property rights or the rights to other contractual obligations. The present advertising payment system is accordingly not limited to the advertising of tangible articles of manufacture, and may be adapted to accommodate any form of advertising including any set of terms or obligations without necessarily departing from the scope of the present invention. Such variations are noted herein where applicable, although the listed alternatives should not be considered to be limiting to the scope of the present invention.

The advertising payment system is provided as a website or a mobile or smart device software application configured to host the advertising image 300 creation and advertising payment process. A seller is any person or entity who wishes to participate in the advertising of goods or services through use of the advertising payment system, wherein a client advertiser is any person or entity who wishes to capitalize on the advertising opportunity by scanning a visual code 240 and shares an advertising link 330 to gain advertising tokens.

The advertising payment system is based on a blockchain protocol, which generally revolves around the use of advertising tokens. In one embodiment, the advertising payment system is based on the technological, decentralized Electro-Optical System (EOS) platform. Such a system utilizes the Delegated Proof of Collision Algorithm (DPOS), which allows for the handling of millions of users and millions of transactions utilizing blockchain technology. A blockchain represents transactions that users make during use of the advertising payment system. The system blockchain produces blocks every 3 seconds. Exactly one manufacturer is entitled to produce a block at any given time. If the block is not created at the scheduled time, the block is skipped. Blocks are produced in 21 rounds. At the start of each round, 21 unique block producers are selected. In each round, the top 20 candidates are automatically selected, and the last manufacturer is selected in proportion to the number of votes compared to other manufacturers having access to the system. The selected manufacturers are shuffled using a random number (pseudo-randomness derived from block time). This shuffling ensures that all manufacturers maintain a balanced relationship with all other manufacturers. It should be noted that the advertising payment system may be based on any blockchain protocol, including, but not limited to, Ethereum.

The advertising payment system is configured to perform payments and create an advertising image 300. A seller first creates an account 50 with the advertising payment system, which establishes an internal digital wallet associated with the account 50. The seller then transfers a desired amount of a cryptocurrency or fiat currency to the advertising payment system for placement within the wallet. The transferred amount of the cryptocurrency or fiat currency may be converted to a corresponding amount of advertising tokens associated specifically with the advertising payment system. The tokens may be created as internal blockchain assets in the same quantity or a different quantity as the originally transferred cryptocurrency or fiat currency. The advertising tokens may be created as a result of the work of internal smart contracts associated with operation of the advertising payment system.

In certain advantageous embodiments, the advertising payment system may be configured to operate in conjunction with client-side image recognition logic executed locally by the second smart device used by the client advertiser. When the visual code 240 is rendered on a graphical interface (e.g., social media feed or streaming overlay), the second smart device may initiate an application-based module or embedded image scanner to perform local validation of the code's format, issuer signature, and expiration metadata. This preliminary analysis can be conducted entirely on-device using a lightweight software library or cryptographic algorithm (e.g., ECC-based signature verification) prior to initiating any network requests or redirection processes.

In certain advantageous embodiments, the advertising payment system may utilize blockchain-based smart contracts to automate the secure issuance and distribution of advertising tokens. Such smart contracts may be deployed within the blockchain protocol used by the advertising payment system and may be configured to execute predefined rules relating to token generation, allocation, and conditional release. For example, a smart contract may define parameters such as a maximum token issuance per campaign, token redemption rates for client advertisers, and escrow conditions for withholding tokens until verification events occur. The execution of these smart contracts may be triggered automatically in response to valid interactions with the advertising image, such as the confirmed sharing of an advertising link 330 or a verified redirect to the user interface of the advertising payment system.

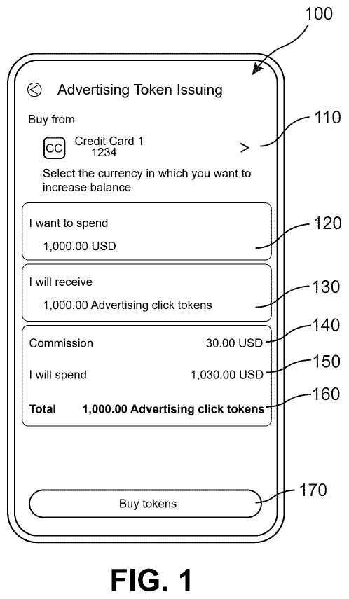

As illustrated by FIG. 1, in an embodiment, a graphical interface that may be associated with a web page or mobile application used to carry out the functions of the advertising payment system as described herein may include an advertising token issuing menu 100 for display to the instant account holder of the advertising payment system. The advertising token issuing menu 100 may include visual indications of a payment method 110 the seller uses to purchase the advertising tokens. The advertising token issuing menu 100 may also include visual indications of how much the seller is willing to spend 120, how many advertising tokens the seller is purchasing 130, a commission 140 that is generated from the purchase, a total amount spent 150 by the seller, a total amount of tokens received 160, and a buy tokens button 170.

As further illustrated by FIG. 1, the advertising token issuing menu 100 may also include an interactive portion for carrying out a transfer of fiat money for advertising tokens between the seller and the advertising payment system. The interactive portion of the advertising token issuing menu 100 may allow for the instant account holder to input different payment methods 110, input the amount that the seller is willing to spend 120 on advertising tokens, and approve the transaction by utilizing the buy tokens button 170.

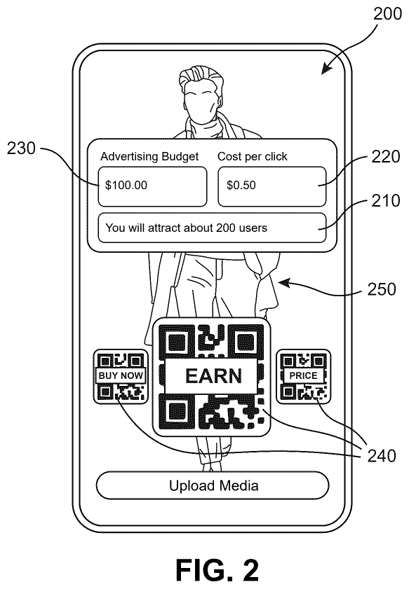

In an embodiment, as illustrated by FIG. 2, a graphical interface that may be associated with a web page or mobile application used to carry out the functions of the advertising payment system as described herein may include an advertising image generator menu 200. The advertising image generator menu 200 may include visual indications of the amount of client advertisers that the advertising image 300 is expected to reach 210. The advertising image generator menu 200 may also include interactive portions that allow the seller to input a total advertising budget 230 and a reward 220 that the client advertiser will receive for sharing an advertising link 330. The interactive portion of the advertising image generator menu 200 may also allow the seller to upload a visualization 250 of the product that the seller would like to advertise. The visualization 250 may take any form as desired by one skilled in the art, including, but not limited to, an image, a photograph, or a video. Finally, the interactive portion of the advertising image generator menu 200 may include a list of visual code 240 designs that the seller may choose from to accompany the visualization 250 in the advertising image 300. The visual code 240 designs may take the form of any visual code as desired by one skilled in the art. In a preferred embodiment, the visual code 240 is a QR code or a bar code. The visual codes 240 may be provided in different types whereby each different type of visual code 240 refers to a different web page or mobile application to which one interacting with the visual code 240 is redirected with each different web page or mobile application including different information, functionality, or features regarding the advertised product or service. For example, some visual codes 240 may be associated with a “buy now” feature where the selected product or service is instantly added to a shopping cart or otherwise advanced towards a purchase, some visual codes 240 may be associated with an informational feature where information associated with the product or service is provided, and some visual codes may be associated with an earning feature where additional client advertisers can become associated with the advertising of the product or service.

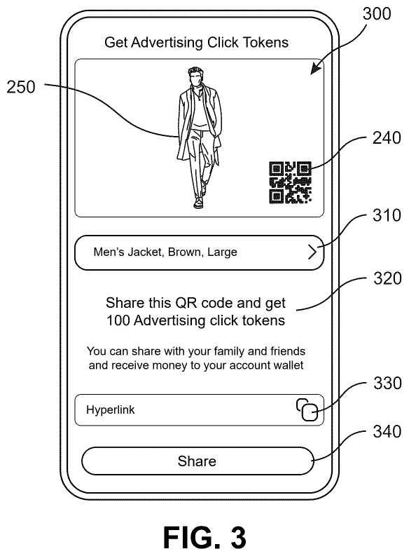

As illustrated by FIG. 3, in an embodiment, when the seller inputs all of the necessary information into the advertising image generator menu 200, the advertising payment system will generate the advertising image 300. The advertising image 300 may be a graphical interface that is associated with a web page or mobile application used to carry out the functions of the advertising payment system as described herein. The advertising image 300 may include visual indications including the visualization 250 of the product being advertised, the visual code 240, a description 310 of the product, and text 320 that encourages the client advertiser to share the advertising link 330. The advertising image 300 may also include an interactive portion which may allow the client advertiser to interact with the advertising link 330 and a share button 340 that allows the advertising client to share the advertising link 330. The share button 340 may allow the advertising client to share the advertising link 330 to any online or offline platform as desired by one skilled in the art.

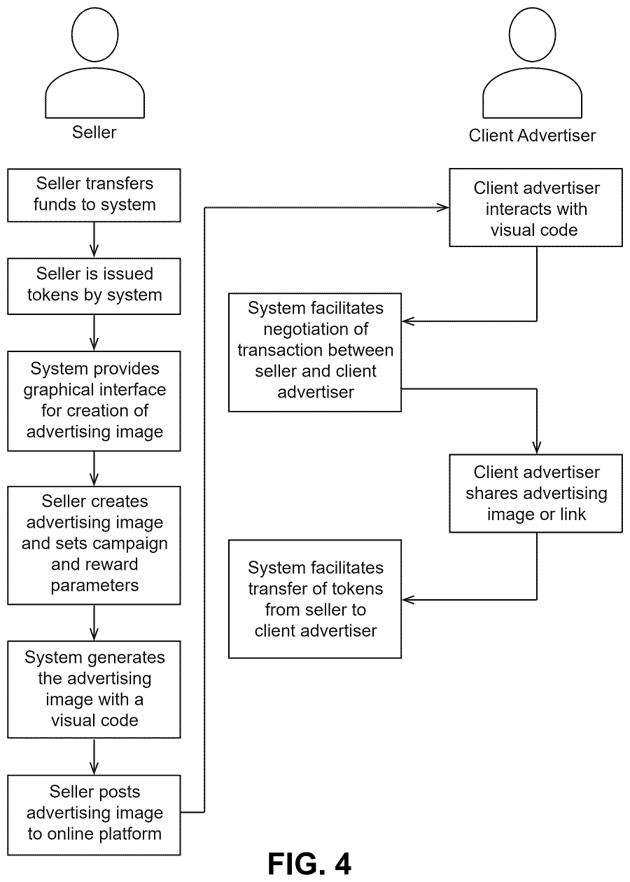

Referring now to FIG. 4, one exemplary method of use of the advertising payment system which includes a transfer of advertising tokens from a seller to a client advertiser in exchange for the client advertiser sharing the advertising link 330 is disclosed. A first step of the disclosed method includes the seller establishing (or logging into) an account with the advertising payment system and transferring the desired amount of cryptocurrency or fiat currency to a virtual wallet within the advertising payment system. The seller may transfer any amount of cryptocurrency or fiat currency to the seller's virtual wallet within the advertising payment system. The virtual wallet may take any form as desired by one skilled in the art.

In a second step, the transferred currency is tokenized into advertising tokens which take the form of internal blockchain currency assets of the advertising payment system through blockchain-based methods. In this step, the advertising payment system negotiates a transaction between a seller and the advertising payment system regarding the acquirement of advertisement tokens by the seller via use of a first smart device. The advertisement system provides the advertising token issuing menu 100 where this transaction may take place. The negotiating of the transaction occurs via communications occurring between the first smart device and another device as facilitated by the advertising token issuing menu 100. The advertising token issuing menu 100 may include visual indications of the payment method 110 the seller uses to purchase the advertising tokens. The advertising token issuing menu 100 may also include visual indications of how much the advertiser is willing to spend 120, how many advertising tokens the seller is purchasing 130, the commission 140 that is generated from the purchase, the total amount spent 150 by the seller, the total amount of tokens received 160, and the buy tokens button 170.

In a third step, the advertising payment system provides a graphical interface that may be associated with a web page or mobile application that allows the user to create an advertising image 300. In an embodiment, the advertising image 300 may include the advertising image generator menu 200. The advertising image generator menu 200 may include visual indications of the amount of client advertisers that the advertising image 300 is expected to reach 210. The advertising image generator menu 200 may also include interactive portions that allow the seller to input the total advertising budget 230 and the reward 220 that the client advertiser will receive for sharing the advertising link 330. The interactive portion of the advertising image generator menu 200 may also allow the seller to upload the visualization 250 of the product that the seller would like to advertise. The visualization 250 may take any form as desired by one skilled in the art, including, but not limited to, an image, a photograph, or a video. Finally, the interactive portion of the advertising image generator menu 200 may include a list of visual code 240 designs that the seller may choose from to accompany the visualization 250 in the advertising image 300. The visual code 240 designs may take the form of any visual code as desired by one skilled in the art. In a preferred embodiment, the visual code 240 is a QR code or a bar code.

In a fourth step, the seller interacts with the graphical interface within the advertising image generator menu 200 and uploads the visualization 250 of the product or service that the seller would like to advertise. The seller may also indicate how many advertising tokens the seller is willing to budget 230 in total in order to advertise the product or service. The seller may also indicate how many advertising tokens the seller is willing to transfer as a reward 220 to each individual client advertiser who chooses to advertise the product or service for the seller.

Once the seller makes these determinations, in a fifth step, the advertising payment system generates the advertising image 300, via use of the first smart device, which includes the visualization 250 of the product or service and the visual code 240, such as a QR code or a bar code, which may be overlaid on the visualization 250 of the product or service. The visual code 240 may be configured to be interacted with by the client advertiser for the good or service via the use of a second smart device. In an embodiment, the advertising image 300 includes the visualization 250 of the good or service and the visual code 240 includes information regarding the good or service. However, the advertising image 300 may include any visualizations, codes, or other components as desired by one skilled in the art.

In a sixth step, the seller may share the advertising image 300 on an online platform, such as on social media or a streaming platform, or an offline platform. However, the seller may share the advertising image 300 to any platform as desired by one skilled in the art. The advertising image 300 may be configured to be visible to the client advertiser during navigation of the platform. This may allow for the client advertiser to view the advertising image 300, and interact with the visual code 240 disposed on the advertising image 300. In a preferred embodiment, the seller shares the advertising image 300 via use of the first smart device. However, the seller may share the advertising image 300 using any smart device as desired by one skilled in the art.

In a seventh step, when the client advertiser interacts with the visual code 240 disposed on the advertising image 300, the advertising payment system redirects to an application executing on the second smart device to a first web address managed by the advertising payment system provided independently of the platform in response to the interacting of the client advertiser with the visual code 240 via use of the second smart device. The redirecting of the application to the web address is based on the information of the visual code 240 and an analysis of the information of the visual code 240 via the second smart device. The web address that is redirected to may be associated with a user interface of the advertising payment system, in an embodiment.

In certain advantageous embodiments, the redirection behavior executed by the second smart device upon scanning the visual code 240 may be dynamically modified based on device characteristics and operating conditions. For example, the application executing on the second smart device may collect technical parameters such as device model, screen resolution, mobile vs. desktop classification, operating system type, battery level, and current network bandwidth. Based on these parameters, the application may select between alternate redirection targets, such as a lightweight HTML fallback interface for low-bandwidth situations, a native in-app interface for mobile contexts, or a rich media landing page for high-performance devices. The redirection decision may also factor in device security settings, biometric authentication availability, or user preferences stored locally on the device.

In some implementations, the application may contact a redirect decision endpoint provided by the advertising payment system and pass the collected device metadata as part of an API request. In other implementations, the redirect logic may be fully embedded within the mobile application itself, allowing redirection decisions to be made locally without external queries. These mechanisms allow the system to deliver adaptive user experiences that align with the device's capabilities and reduce the likelihood of error-prone or poorly rendered interactions following ad engagement.

In advantageous embodiments, the second smart device may first perform a client-side verification of the visual code 240 prior to redirecting to any network location. This may include scanning and decoding the visual code using an application-based decoder, verifying that the visual code matches a format associated with the advertising payment system, checking an embedded digital signature or hashed checksum to confirm authenticity, and extracting embedded campaign metadata, such as a token ID, seller ID, or expiration timestamp. If the visual code passes all client-side validation checks, then and only then does the second smart device redirect the user to the remote address or advertising payment interface. If the code fails validation, an error message may be displayed to the user, and no communication is made to the backend server. Such localized validation improves security, reduces fraudulent redirection attempts, and lowers the computational burden on centralized infrastructure.

In some embodiments, the advertising payment system may be configured to include cryptographic verification of the data payload embedded within the visual code 240. Specifically, each visual code may contain an encoded message that includes one or more data fields, such as a campaign identifier, token denomination, timestamp, and issuing seller ID, along with a digital signature generated using a private key known only to the advertising payment system or authorized sellers. Upon scanning the visual code, the second smart device may extract this payload and execute a public key verification process to confirm that the signature corresponds to an authorized issuer. The public key used for verification may be embedded in the application or retrieved from a secure source over an encrypted channel.

If the digital signature fails verification, the smart device may suppress any redirection attempt and display an error message indicating a possible tampering attempt. In certain embodiments, the visual code may also include a nonce or one-time-use token, and the device may check with the advertising payment system to confirm that the code has not already been redeemed. This cryptographic verification mechanism helps prevent spoofing of campaign links, unauthorized duplication of reward paths, and replay of expired or revoked advertisements. All signature validation logic may be executed locally on the device to reduce communication overhead and improve real-time responsiveness.

In certain advantageous embodiments, the second smart device may implement real-time image processing capabilities to recognize and extract the visual code 240 from the advertising image 300 using on-device computer vision techniques. This may include preprocessing steps such as edge detection, thresholding, perspective correction, and orientation normalization to ensure accurate detection even in the presence of glare, skew, or partial obstruction. The application may utilize a trained visual model or heuristic matching to differentiate valid advertising images from unrelated content or counterfeit codes. In some cases, the visual code may be embedded as part of a stylized or semi-transparent overlay on the advertising image, and the image processing module may apply contour tracking or contrast-enhancement filters to isolate the scannable area with high confidence.

Once identified, the code region may be decoded locally using a library optimized for mobile hardware, such as a native C/C++ implementation or GPU-accelerated decoding pipeline. These processes may enable sub-second scan times and reduce dependence on continuous autofocus hardware. In certain configurations, the smart device may provide real-time visual or haptic feedback (e.g., border highlight or vibration) to indicate successful code detection and verification. The local implementation of this image processing logic improves scanning reliability and responsiveness while reducing server load and network dependence.

The client advertiser may interact with the visual code 240 utilizing any method as desired by one skilled in the art. The client advertiser may interact with the visual code 240 via the use of the second smart device. However, the client advertiser may interact with the visual code 240 with any smart device as desired by one skilled in the art. In one embodiment, the client advertiser interacts with the visual code 240 by scanning the visual code 240 using a camera of the second smart device when the visual code 240 is visibly displayed on a graphical interface of a third smart device during navigation of the platform via the third smart device. In another embodiment, the client advertiser interacts with the visual code 240 by detecting a presence of the visual code 240 being visibly displayed on a graphical interface of the second smart device during navigation of the online platform via the second smart device and prompting the buyer to select the visual code following detection thereof.

In an embodiment, the web address redirected to may be associated with a graphical interface that allows the client advertiser to view the product or service being advertised and provides the client with the option to share the advertising link 330 that the advertising payment system has generated. In one embodiment, the web address that the interaction with the visual code 240 redirects to is a graphical interface containing the advertising image 300. The advertising image 300, in an embodiment, includes visual indications including the visualization 250 of the product being advertised, the visual code 240, the description 310 of the product, and text 320 that encourages the client advertiser to share the advertising link 330. The advertising image 300 may also include an interactive portion which may allow the advertising client to interact with the advertising link 330, and the share button 340 that allows the advertising client to share the advertising link 330. The share button 340 may allow the advertising client to share the advertising link 330 to any online or offline platform as desired by one skilled in the art. The advertising link 330 may redirect to a web address or online application that is associated with a graphical interface that allows another user to view or buy the product or service. However, the advertising link 330 may redirect to any web address as desired by one skilled in the art.

In an eighth step, the advertising payment system facilitates negotiation of a transaction of the advertising tokens between the client advertiser and the seller regarding the advertisement of the good or service using the advertising image 300 corresponding to the visual code 240 interacted with by the client advertiser following the redirecting of the second smart device to the user interface of the advertising payment system. In an embodiment, the negotiating of the transaction occurs via communications occurring between the first smart device and the second smart device as facilitated by the advertising payment system independently of the platform as to which the advertising image 300 is shared. However, the transaction may occur via communications between any two smart devices as desired by one skilled in the art.

In a ninth step, the client advertiser “clicks” the share button 340 to share the advertising link 330 to an online platform, and in a tenth step the advertising payment system automatically transfers advertising tokens into the virtual wallet associated with the client advertiser's account that has been established with the advertising payment system in reaction to completion of the ninth step. The amount of advertising tokens that the client advertiser receives may be directly correlated to the total advertising budget 230 and the reward 220 that the seller designates that the client advertiser will receive for sharing the advertising link 330. In an embodiment, once the advertising tokens are transferred to the virtual wallet of the client advertiser, the client advertiser may use those advertising tokens to purchase products sold within the advertising payment system. In another embodiment, the client advertiser may also use the advertising payment system to transfer advertising tokens back into fiat money of a denomination of the client advertiser's choice. It should be noted that the client advertiser may use the advertising tokens in any way desired by one skilled in the art.

In some embodiments, the transfer of advertising tokens from the seller's virtual wallet to the client advertiser's virtual wallet may be governed and executed by a smart contract recorded on the blockchain protocol associated with the advertising payment system. The smart contract may be configured to validate certain conditions before executing a token transfer. These conditions may include, for instance, verifying that the visual code 240 was previously authenticated by the mobile application, confirming that the associated advertising image 300 has not already been used by the same client advertiser to receive tokens, or confirming that the campaign associated with the seller's advertising image remains active. When the conditions defined by the smart contract are satisfied, the smart contract may automatically initiate a transfer of the advertising tokens to the client advertiser's wallet and record the transaction to the blockchain ledger. In this way, the system may allow for secure, trustless execution of token disbursements without requiring direct oversight from a centralized authority.

In some advantageous embodiments, the advertising payment system may be configured to operate in a serverless computing environment in which smart contract execution, event monitoring, and token transfer logic are handled by distributed nodes in a blockchain network or a function-as-a-service (FaaS) infrastructure. For example, a smart contract may be deployed to a decentralized ledger platform such that the logic governing token distribution is not executed by any dedicated server under the control of the operator. When predefined events, such as a verified visual code scan or a confirmed user engagement, are triggered, the blockchain network itself may execute the relevant smart contract and distribute tokens directly to the client advertiser's wallet address without routing the transaction through a centralized platform.

In certain implementations, the system may use event-driven cloud functions (e.g., AWS Lambda, Cloudflare Workers, or similar) to handle verification, logging, or analytics tasks in response to specific events (such as QR code activation or engagement confirmation), thereby eliminating the need for persistent backend services. This approach improves system scalability, reduces infrastructure costs, and increases fault tolerance in the presence of spikes in user activity or regional outages. It also minimizes attack surfaces by reducing server-side state and using ephemeral execution contexts that are automatically validated by cryptographic proofs or decentralized consensus.

In certain advantageous embodiments, the advertising payment system may be configured to preserve user privacy throughout the token distribution process. For example, when a client advertiser interacts with a visual code 240, the system may allow for validation of the share or engagement event without transmitting any persistent user identifier or device-level metadata. Engagements may be recorded using ephemeral session tokens or zero-knowledge proofs that confirm user participation without revealing identity. In some implementations, the system may employ stealth addresses or ring signature mechanisms so that the destination wallet receiving advertising tokens is unlinkable to a specific user without cryptographic consent.

In still further embodiments, the client advertiser application may support “private mode” interactions, where blockchain transactions associated with reward transfers are obfuscated using mixers, anonymous tokens, or time-delayed execution pathways. The system may also allow advertisers to opt in or out of privacy-enhancing modes based on campaign requirements or jurisdictional rules. No biometric, contact list, GPS, or similar PII need be collected for the advertising payment system to function. These privacy-preserving features enhance user trust and broaden the applicability of the platform in regulated or privacy-sensitive contexts.

In certain advantageous embodiments, the advertising payment system may further include an integrated analytics dashboard for enabling participants to monitor, audit, and verify advertising campaign performance and token distribution in real time. The dashboard may be accessible via a graphical user interface (GUI) associated with the web page or mobile application and may be rendered based on live or near-real-time data pulled from the underlying blockchain infrastructure and associated smart contracts.

In some embodiments, the dashboard may be tailored to different user types, such as sellers, client advertisers, or administrators. For example, a seller-facing dashboard may display real-time campaign performance metrics including the number of visual code interactions per campaign, the number of unique advertising link shares, click-through rates, engagement durations, confirmed conversions, the remaining advertising token budget, and a log of advertising token disbursements associated with each client advertiser. A client advertiser-facing dashboard may similarly provide a detailed breakdown of each advertisement shared, the associated campaign ID, timestamped logs of engagement events such as link clicks or conversions, the number of tokens received per campaign, and cumulative reward earnings tracked over selectable time intervals.

In a preferred implementation, the dashboard may retrieve and parse smart contract event logs directly from the blockchain ledger to ensure tamper-resistant data collection. For example, each time a token transfer is executed by a smart contract, the event may be appended to the public ledger and exposed through an event listener associated with the user's dashboard. This approach allows both sellers and advertisers to verify that token distributions occurred as expected and that they conform to the campaign conditions established in the smart contract.

In other implementations, the dashboard may include advanced filters and visualizations (e.g., graphs, heat maps, timelines) that provide insight into campaign trends or historical performance, optionally supporting CSV export or integration with external analytics platforms via APIs. The dashboard may also trigger alerts or warnings when budget thresholds are exceeded, engagement drops below expectations, or unusual traffic patterns suggest fraudulent activity.

These analytics dashboard features offer transparency and auditability, thereby increasing user trust and promoting accountability within the decentralized advertising ecosystem. Because the dashboard interfaces with blockchain-anchored data in a tamper-resistant and verifiable manner, it improves the security and operational integrity of the overall computing system in which the advertising payment system executes.

In certain advantageous embodiments, the advertising payment system may further incorporate dynamic feedback mechanisms to adjust the amount of advertising tokens awarded to a client advertiser in real time. For example, after the client advertiser shares the advertising link 330, the advertising payment system may monitor engagement metrics associated with the shared link, such as the number of clicks, duration of visits, or confirmed conversions (e.g., purchases, form submissions, or follow-up engagements). These metrics may be collected via embedded tracking pixels, API callbacks from merchant servers, or blockchain-based event logs.

In response to the detected engagement level, a feedback-driven token allocation system may adjust the final number of advertising tokens distributed to the client advertiser. If the shared advertisement generates higher-than-expected traffic or verified actions, the smart contract may automatically increase the reward, thereby incentivizing high-performing advertising behaviors. Conversely, in the event of low engagement or suspected fraudulent interactions, the contract may cap or reduce the token payout or trigger a manual review.

This adaptive allocation may be implemented using smart contracts capable of evaluating real-time or delayed feedback inputs before executing token transfers. In some implementations, client advertisers may be notified of potential bonus token tiers based on engagement thresholds. These bonus levels may also be visualized within the mobile or web interface of the advertising payment system to encourage more strategic sharing behaviors. The reward structure may also include decay functions, whereby token values decline if no engagement is registered within a defined time period after sharing.

The examples established above may be representative of a seller using the advertising payment system to incentivize client advertisers to advertise the seller's product on online or offline platforms. The examples may also be representative of how client advertisers may benefit from sellers using the advertising payment system to advertise products. Additionally, the examples may be representative of how small businesses may use the advertising payment system to advertise products given a limited budget and a small advertising team.

In further embodiments, the advertising payment system may support interoperability with third-party cryptocurrency wallets, dApps, or decentralized identity providers. For instance, when a client advertiser earns advertising tokens through valid engagement with a shared visual code 240, the tokens may be transferred not only to an in-app wallet but optionally to an external wallet specified by the user. The application may interface with wallet protocols such as WalletConnect, MetaMask, or similar standards-compliant APIs to facilitate token transfers outside the core application environment. Authentication of external wallet ownership may be performed using cryptographic challenge-response protocols to ensure token security.

In still further embodiments, earned tokens may be made available to other smart contract systems, such as decentralized finance (DeFi) platforms, loyalty programs, or governance protocols. The advertising payment system may include bridging functionality or token-wrapping support to facilitate cross-chain or cross-platform compatibility. All such interoperability features may be governed by permissions settings within the user's application and subject to revocable cryptographic authorization, ensuring that system security and auditability are preserved even when external integrations are used.

These interoperability features contribute to a technical improvement in the field of decentralized application architecture by enabling seamless, secure communication between the advertising payment system and third-party blockchain-based platforms. By supporting wallet abstraction layers and cross-system token flows, the system promotes user autonomy and extensibility while preserving integrity through cryptographically enforced permissions. These capabilities improve the utility and scalability of blockchain-based advertising models and reduce friction in token redemption and management across heterogeneous platforms.

As a further advantage of certain embodiments disclosed herein, the use of blockchain-based smart contracts for managing advertising token transactions may represent a technical improvement to the field of secure electronic payments and decentralized incentive systems. Unlike conventional systems that rely on centralized control or manual processes to distribute rewards, the disclosed advertising payment system may utilize smart contracts to automate token distribution in a transparent and tamper-resistant manner. The use of such smart contracts enables reliable execution of complex business logic (e.g., conditional transfers, campaign budget enforcement, and user-specific limits) without reliance on a trusted intermediary. By embedding the reward conditions within the distributed ledger infrastructure, the system improves transaction reliability, enhances fraud resistance, and reduces latency in token delivery, thereby improving the functioning of the underlying computing environment in which the advertising payment system operates.

As an additional technical improvement, certain embodiments disclosed herein may perform decentralized validation of visual advertising codes directly on the client device. By enabling client-side scanning and verification of visual code authenticity, prior to initiating network-based redirection or backend token processing, the system reduces susceptibility to phishing, spoofing, or malicious code injection. Moreover, this distributed validation architecture reduces load on centralized servers, enhances data privacy by minimizing unnecessary transmissions, and enables faster, more secure user interaction with shared advertisements. Such features collectively enhance the technical performance and reliability of the computing environment in which the advertising payment system operates.

The incorporation of real-time feedback-driven token allocation mechanisms provides a technical improvement to the field of decentralized advertising and automated incentive distribution. By integrating engagement analytics into blockchain smart contract logic, the system enables adaptive, behavior-sensitive reward models that promote quality over quantity in advertisement sharing. This dynamic model not only enhances the fairness and efficiency of reward distribution but also reduces the prevalence of low-value or spam-based advertising activity, thereby improving the overall functioning of the computing infrastructure supporting the system.

As an additional technical advantage, the analytics dashboard described in certain embodiments of the advertising payment system provides real-time, user-facing transparency into system behavior by retrieving and displaying tamper-resistant transaction data derived from a decentralized blockchain ledger. This facilitates secure and verifiable campaign monitoring without the need for centralized reconciliation or manual intervention. By exposing event-driven smart contract outputs in a structured, queryable format, the dashboard improves the technical field of distributed application interfaces and enhances auditability in systems involving programmatically governed token flows. This contributes to a more trustworthy and efficient computing environment by enabling participants to verify performance metrics, reward disbursements, and system compliance through direct interaction with immutable data sources.

Still further, certain embodiments described herein improve the security and integrity of advertising token systems by incorporating cryptographic verification of encoded advertisement payloads directly on the client device. By leveraging public key infrastructure to verify the origin and authenticity of visual codes, the system resists spoofing, duplication, and unauthorized modification of promotional materials. This enhances trust in decentralized advertising workflows and reduces reliance on centralized gatekeepers or manual fraud review processes. The described approach thereby contributes to a technical improvement in the field of secure data authentication and user-controlled cryptographic validation on mobile computing devices.

Furthermore, embodiments of the advertising payment system that include on-device image processing improve the technical field of real-time mobile computer vision. By enabling robust and efficient scanning of visual codes in suboptimal conditions, and without requiring server-based preprocessing, the system enhances the functionality of smart devices as scanning platforms. These improvements reduce latency, improve user responsiveness, and enable consistent behavior across heterogeneous hardware. The integration of tailored visual detection techniques with secure reward validation workflows contributes to an overall improvement in the technical architecture supporting decentralized digital advertising systems.

As another technical improvement, certain embodiments described herein dynamically tailor redirect behavior based on client device context and operating conditions. By adjusting the post-scan experience in accordance with parameters such as network speed, screen resolution, or battery state, the system improves the reliability and responsiveness of advertising interactions across heterogeneous device environments. This enhances the technical operation of smart devices by avoiding incompatible or poorly optimized redirections and reduces user friction in mobile-based advertising campaigns. These features collectively improve the technical architecture of digital redirection and interaction protocols within decentralized incentive systems.

As an additional technical improvement, the use of serverless or decentralized smart contract execution environments improves the resiliency, scalability, and operational integrity of the advertising payment system. By removing the dependency on centralized application servers and shifting execution logic to a decentralized or ephemeral infrastructure, the system becomes less vulnerable to system-wide failures, denial-of-service attacks, and manipulation by privileged insiders. These improvements advance the technical field of distributed application design and align with best practices for trust-minimized computing, offering a robust architectural foundation for secure, real-time tokenized advertising workflows.

The use of privacy-preserving token distribution techniques, such as zero-knowledge proof-based validation or stealth address routing, improves the technical field of privacy-aware computing and secure distributed incentive systems. These enhancements enable secure token transfers and campaign engagement tracking without exposing user identities or requiring centralized data storage. By minimizing the disclosure of PII while still ensuring verifiable reward logic, the system provides a technical improvement over prior advertising platforms that require continuous user surveillance or centralized user profiling. This architecture allows for compliant, user-friendly deployment in environments demanding strong privacy guarantees.

The advertising payment system disclosed herein provides several improvements over conventional online advertising methods. The system allows sellers to compensate client advertisers directly through the use of blockchain-based advertising tokens, without relying on a centralized bidding platform. This direct compensation model reduces overhead, simplifies campaign setup, and enables broader participation in advertising activities, including by individuals and small businesses. The use of visual codes embedded within advertising images further allows for simplified engagement workflows that do not require integration with external platforms or traditional ad servers.

The combination of client-side scanning, cryptographic validation, and blockchain-based token distribution provides specific technical advantages. For example, performing validation of a visual code entirely on the client device reduces server load, improves user response time, and prevents invalid or spoofed code interactions from reaching backend systems. Similarly, the use of smart contracts to govern token distribution ensures that payments are only made when defined conditions are met, such as confirmed sharing activity or verified user engagement. These features improve the accuracy and reliability of token transfers while reducing opportunities for fraudulent behavior.

By combining multiple technical elements, such as smart contract automation, device-level verification, and adaptive redirect logic, the system improves the performance and security of advertising-related transactions. These features also reduce reliance on centralized infrastructure, which improves scalability and system uptime. When implemented together, the features described herein result in a system that is capable of operating under varied device conditions while still preserving the integrity of token distribution events and ensuring compliance with the reward terms defined by sellers.

The system further supports user privacy by minimizing the collection of personal data during code scanning or token distribution. In some embodiments, advertising tokens are transferred without requiring persistent user identifiers or external account linking. This allows the system to operate in jurisdictions with strict privacy requirements and reduces the amount of data exposed during advertising transactions. The inclusion of privacy-preserving features, when combined with blockchain-based auditability and on-device processing, contributes to an overall improvement in system transparency and user trust without requiring centralized identity management.

Taken together, the features described herein provide a specific technical solution to problems encountered in prior advertising systems, including fraud prevention, scalability limitations, latency in token distribution, and user privacy concerns. These improvements are implemented through a combination of computing processes that improve the operation of the system as a whole and provide a practical application of blockchain, cryptographic, and image processing technologies to the field of distributed advertising.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A system for facilitating advertising transactions between a seller and a client advertiser, the system comprising:
one or more processors;
a blockchain protocol executed by the one or more processors, the blockchain protocol associated with one or more smart contracts configured to govern token generation, allocation, and conditional transfer events;
a graphical user interface configured to be accessed by a first smart device associated with the seller, the graphical user interface comprising:
a token issuing interface configured to enable the seller to acquire advertising tokens through conversion of fiat or cryptocurrency, the advertising tokens representing a digital reward value assignable to advertising sharing events, and
an advertising image generator interface configured to receive from the seller a visualization associated with a product or service and parameters defining one or both of a total advertising budget and/or a reward amount per each sharing event;
a visual code generator executable by the one or more processors to encode information regarding the product or service into a visual code and to generate an advertising image comprising the visualization and the visual code;
a redirection module configured to redirect a second smart device associated with the client advertiser to a web address associated with the graphical user interface of the system in response to an interaction of the client advertiser with the visual code; and
a decentralized token disbursement module configured to execute a smart contract on the blockchain protocol to conditionally release advertising tokens from a digital wallet associated with the seller to a digital wallet associated with the client advertiser, the smart contract being triggered upon a verified sharing event performed by the client advertiser with respect to the advertising image, wherein the smart contract defines disbursement conditions based at least in part on confirmation of the client advertiser sharing the advertising image or a link derived therefrom.

2. The system of claim 1, wherein the system operates without requiring a centralized application server to perform verification or token transfer logic.

3. The system of claim 1, wherein the visual code is a QR-code or bar code.

4. The system of claim 1, wherein the advertising image includes the visual code displayed over or adjacent the visualization of the good or service associated therewith.

5. The system of claim 1, wherein the advertising tokens are generated as internal blockchain assets through execution of a smart contract initiated by the seller's purchase of tokens via the token issuing interface.

6. The system of claim 5, wherein the smart contract executed for generating the advertising tokens records the token issuance event to a blockchain ledger and includes a timestamp and seller account identifier.

7. The system of claim 1, wherein the graphical user interface is further configured to enable the seller and the client advertiser to exchange communications relating to advertising token reward terms.

8. The system of claim 1, wherein the graphical user interface enables the seller to initiate sharing of the advertising image to a first platform, wherein the first platform is a publicly accessible content-sharing network, online marketplace, or social media platform.

9. The system of claim 8, wherein the advertising image is visible to the client advertiser when navigating the first platform prior to the client advertiser providing login credentials to the first platform.

10. The system of claim 8, wherein the client advertiser is enabled by the user interface to generate a distinct advertising link from the advertising image and share the advertising link to a second platform separate from the first platform.

11. The system of claim 10, wherein the second platform comprises a different platform from the first platform, and wherein each sharing event to the second platform triggers a distinct recordable engagement on a blockchain ledger.

12. The system of claim 1, wherein the visual code generator embeds one or more of a campaign identifier, a token denomination, or a seller ID into the visual code in an encrypted or digitally signed format.

13. The system of claim 12, wherein the smart contract validates an embedded campaign identifier prior to executing a token disbursement from the seller's wallet to the client advertiser's wallet.

14. The system of claim 1, wherein the smart contract defines a rule set that includes a token disbursement schedule to the client advertiser based on one or more engagement metrics associated with the shared advertising link.

15. The system of claim 14, wherein the engagement metrics comprise one or more of: number of views, clicks, conversions, or verified user interactions associated with the advertising link.

16. The system of claim 14, wherein the smart contract adjusts the number of advertising tokens disbursed to the client advertiser based on achievement of a threshold value with respect to one or more of the engagement metrics.

17. The system of claim 1, wherein the graphical user interface includes a dashboard configured to retrieve smart contract event logs from a blockchain ledger and display real-time campaign performance and reward distribution metrics to the seller and the client advertiser.

18. The system of claim 1, wherein the decentralized token disbursement module is configured to execute transfers of advertising tokens without storing any persistent user identifiers.

19. The system of claim 1, wherein the decentralized token disbursement module supports interoperability with third-party cryptocurrency wallets.

20. A method for facilitating advertising transactions between a seller and a client advertiser, the method comprising:
executing, by one or more processors, a blockchain protocol comprising a plurality of smart contracts configured to govern token generation, allocation, and conditional transfer events;
providing, via a graphical user interface accessible by a first smart device associated with the seller:
a token issuing menu enabling the seller to acquire advertising tokens through conversion of fiat or cryptocurrency, the advertising tokens representing a digital reward value assignable to advertising sharing events; and
an advertising image generator menu configured to receive from the seller a visualization associated with a product or service and parameters defining one or both of a total advertising budget and/or a reward amount per each sharing event;
generating, by a visual code generator executable by the one or more processors, a visual code encoding information regarding the product or service;
producing an advertising image comprising the visualization and the visual code;
publishing the advertising image on a platform such that it is accessible to a second smart device associated with the client advertiser;
in response to an interaction by the client advertiser with the visual code via the second smart device, redirecting the second smart device to a web address associated with the graphical user interface of the system;
receiving, by the system, confirmation of a verified sharing event performed by the client advertiser with respect to the advertising image or a link derived therefrom; and
executing, by one of the smart contracts within the blockchain protocol, a conditional transfer of advertising tokens from a digital wallet associated with the seller to a digital wallet associated with the client advertiser, in accordance with disbursement conditions defined by the one of the smart contracts.
